(19) United States
(12) Patent Application Publication
(10) Pub. No.: US 2021/0347608 A1
(43) Pub. Date: Nov. 11, 2021

(54) ELEVATOR TENSION MEMBER END TERMINATION

(71) Applicant: TK Elevator Innovation and Operations GmbH, Essen (DE)

(72) Inventor: Frank Dudde, Collierville, TN (US)

(73) Assignee: TK Elevator Innovation and Operations GmbH, Essen (DE)

(21) Appl. No.: 17/250,762

(22) PCT Filed: Sep. 4, 2018
(86) PCT No.: PCT/EP2018/073724

§ 371 Date: Mar. 2, 2021

(51) Int. Cl. B66B 7/08

(52) U.S. Cl. CPC B66B 7/085

(57) ABSTRACT

An end termination clamp for a tension member includes a linkage configured for connection to a structural element and a first plate opposite a second plate defining a space therebetween to accept the tension member. Each of the first and second plates have a linkage end connected to the linkage, a belt entrance end, and a main body extending between the linkage and belt entrance ends. The first and second plates respectively define first and second clamping surfaces configured to abut opposite sides of a tension member. The end termination clamp further includes at least one fastener connecting the first plate and second plate to clamp the tension member in the space therebetween. The first and second clamping surfaces are narrower than a width of the tension member at the belt entrance end of the first and second plates.

### BACKGROUND OF THE INVENTION

### Field of the Invention

The present disclosure is generally directed to elevator systems and, more particularly, a tension member end termination. Even more particularly, the present disclosure is directed to a clamp-type tension member end termination for use in elevator systems.

### Description of Related Art

Elevators for vertically transporting people and goods are an integral part of modern residential and commercial buildings. A typical elevator system includes an elevator car raised and lowered by a hoist system. The hoist system typically includes one or more tension members such as elevator belts or ropes connecting the elevator car to a counterweight. The tension members are routed over drive and idler sheaves. The elevator car is raised or lowered due to frictional traction between the tension members and the rotating drive sheaves. A variety of tension member types, including wire rope, V-belts, flat belts, and chains, may be used, with the sheave assemblies having corresponding running surfaces to transmit tractive force between the tension members and the sheave assemblies.

Each tension member is affixed to one or more structural elements of the elevator system, such as the support frame, car, or counterweight, via an end termination which typically secures the tension member in place via a wedging and/or clamping action. This wedging and/or clamping action may introduce stress concentrations to the tension member, particularly where the tension member enters the end termination, making the tension members substantially more prone to fail at or near the end termination than along the remainder of its length. Such stress concentrations are particularly exacerbated when the tension member is misaligned with or sways relative to the end termination.

Additionally, conventional end terminations apply a clamping force uniformly across the width of the tension member. This clamping arrangement is problematic in that many types of tension members, particularly flattened tension members such as belts, react differently to loads applied at their edges compared to loads applied centrally. As such, conventional end terminations may introduce high stress concentrations at or near the edges of the tension members, even if the clamping force is reduced to minimize stress concentration at the center of the tension member.

Still further, conventional end terminations impart a substantially constant clamping force along the length of the tension member received in the end termination. While the clamping force must be high to prevent slippage of the tension member from the end termination, increasing the clamping force also increases the stress concentrations where the tension member enters the end termination.

These and other limitations of conventional end terminations are particularly acute when composite tension members are utilized. Composite tension members, which may include materials such as carbon fiber, aramid fiber, glass fiber, and nylon reinforced in a polymer matrix, are particularly susceptible to fatigue failures due to compressive load cycles, shock or impact loads, and bending.

### SUMMARY OF THE INVENTION

In view of the foregoing, there exists a need for elevator tension member end terminations which introduce relatively minimal or reduced stress concentrations to the tension members, while still providing sufficient clamping force to prevent the tension member from slipping out of the end termination.

Aspects of the present disclosure are directed to an elevator system including at least one elevator car configured to be raised and lowered by a tension member and an end termination clamp for the tension member. The end termination clamp includes a linkage configured for connection to a structural element and a first plate opposite a second plate defining a space therebetween to accept the tension member. Each of the first plate and the second plate have a linkage end connected to the linkage, a belt entrance end, and a main body extending between the linkage end and the belt entrance end. The first plate defines a first clamping surface configured to abut a first side of the tension member, and the second plate defines a second clamping surface configured to abut a second side of a tension member. The end termination clamp further includes at least one fastener connecting the first plate and the second plate to clamp the tension member in the space between the first plate and the second plate. The first clamping surface and the second clamping surface are narrower than a width of the tension member at the belt entrance end of the first plate and the second plate.

In some aspects, the belt entrance end of the first plate and the second plate tapers inward from the main body such that a width of the belt entrance end is narrower than a width of the main body for each of the first plate and the second plate.

In some aspects, at least a portion of the belt entrance end of the first plate and the second is curved.

In some aspects, the curved portion of the belt entrance end of the first plate and the second plate has a predetermined radius of curvature of between about 5 mm and about 200 mm.

In some aspects, the belt entrance end of the first plate and the second plate narrows inward from the main body and defines a polygonal shape.

In some aspects, the polygonal shape is trapezoidal.

In some aspects, the belt entrance end of the first plate and the second plate is asymmetric about a longitudinal axis parallel to the tension member and bisecting the main body of the first plate and the second plate.

In some aspects, each of the first clamping surface and the second clamping surface is asymmetric about a longitudinal axis parallel to the tension member and bisecting the main body of the first plate and the second plate.

In some aspects, the asymmetrical shape of the first clamping surface and the second clamping surface are selected to define a predetermined clamp pressure profile to the tension member.

In some aspects, the main body of at least one of the first plate and the second plate defines a window through which a held end of the tension member is visible.

In some aspects, the belt entrance end of the first plate and the second plate is deflectable relative to the main body of the first plate and the second plate.

In some aspects, the belt entrance end is deflectable in a direction parallel to a direction of transverse sway or lateral sway of the tension member held between the first clamping surface and the second clamping surface.

In some aspects, the end termination clamp further includes a sway brake extending from the main body of the first plate and the second plate and engaging the tension member held between the first clamping surface and the second clamping surface.

In some aspects, the sway brake includes a damper to counteract lateral sway of the tension belt of the tension member held between the first clamping surface and the second clamping surface.

In some aspects, the at least one fastener includes a plurality of fasteners connecting the first plate and the second plate to clamp the tension member in the space between the first plate and the second plate. The plurality of fasteners are distributed evenly on the main body of the first plate and the second plate between the linkage end and the belt entrance end.

In some aspects, the fasteners closer to the linkage end are tightened to provide greater clamp pressure than the fasteners closer to the belt entrance end.

Other aspects of the present disclosure are directed to a method for connecting an end termination clamp to an elevator tension member. The method includes providing a first plate opposite a second plate to define a space therebetween. Each of the first plate and the second plate have a linkage end, a belt entrance end, and a main body extending between the linkage end and the belt entrance end. The first plate defines a first clamping surface, and the second plate defines a second clamping surface. The method further includes inserting the tension member into the space between the first plate and the second plate such that the first clamping surface abuts a first side of the tension member and the second clamping surface abuts a second side of the tension member. The method further includes connecting the first plate and the second plate with at least one fastener to clamp the tension member in the space between the first plate and the second plate. The first clamping surface and the second clamping surface are narrower than a width of the tension member at the belt entrance end of the first plate and the second plate.

In some aspects, the method further includes connecting a linkage to the linkage end of the first plate and the second plate.

In some aspects, the at least one fastener includes a plurality of fasteners connecting the first plate and the second plate to clamp the tension member in the space between the first plate and the second plate. The plurality of fasteners are distributed evenly on the main body of the first plate and the second plate between the linkage end and the belt entrance end. The method further includes tightening the fasteners closer to the linkage end to provide greater clamp pressure than the fasteners closer to the belt entrance end.

In some aspects, the step of tightening the fasteners closer to the linkage end to provide greater clamp pressure than the fasteners closer to the belt entrance end includes using one of a linearly increasing or an exponentially increasing clamp pressure for the plurality of fasteners between the linkage end and the belt entrance end.

Other aspects of the present disclosure are directed to an end termination clamp for a tension member. The end termination clamp includes a linkage configured for connection to a structural element and a first plate opposite a second plate defining a space therebetween to accept the tension member. Each of the first plate and the second plate have a linkage end connected to the linkage, a belt entrance end, and a main body extending between the linkage end and the belt entrance end. The first plate defines a first clamping surface configured to abut a first side of the tension member, and the second plate defines a second clamping surface configured to abut a second side of a tension member. The end termination clamp further includes at least one fastener connecting the first plate and the second plate to clamp the tension member in the space between the first plate and the second plate. The first clamping surface and the second clamping surface are narrower than a width of the tension member at the belt entrance end of the first plate and the second plate.

In some aspects, the belt entrance end of the first plate and the second plate tapers inward from the main body such that a width of the belt entrance end is narrower than a width of the main body for each of the first plate and the second plate.

In some aspects, at least a portion of the belt entrance end of the first plate and the second is curved.

In some aspects, the curved portion of the belt entrance end of the first plate and the second plate has a predetermined radius of curvature of between about 5 mm and about 200 mm.

In some aspects, the belt entrance end of the first plate and the second plate narrows inward from the main body and defines a polygonal shape.

In some aspects, the polygonal shape is trapezoidal.

In some aspects, the belt entrance end of the first plate and the second plate is asymmetric about a longitudinal axis parallel to the tension member and bisecting the main body of the first plate and the second plate.

In some aspects, each of the first clamping surface and the second clamping surfaces is asymmetric about a longitudinal axis parallel to the tension member and bisecting the main body of the first plate and the second plate.

In some aspects, the asymmetrical shape of the first clamping surface and the second clamping surface are selected to define a predetermined clamp pressure profile to the tension member.

In some aspects, the main body of at least one of the first plate and the second plate defines a window through which a held end of the tension member is visible.

In some aspects, the belt entrance end of the first plate and the second plate is deflectable relative to the main body of the first plate and the second plate.

In some aspects, the belt entrance end is deflectable in a direction parallel to a direction of transverse sway or lateral sway when the tension member is held between the first clamping surface and the second clamping surface.

In some aspects, the end termination clamp further includes a sway brake extending from the main body of the first plate and the second plate and engaging the tension member when the tension member is held between the first clamping surface and the second clamping surface.

In some aspects, the sway brake includes a damper to counteract lateral sway of the tension belt when the tension member is held between the first clamping surface and the second clamping surface.

In some aspects, the at least one fastener includes a plurality of fasteners connecting the first plate and the second plate to clamp the tension member in the space between the first plate and the second plate, the plurality of fasteners distributed evenly on the main body of the first plate and the second plate between the linkage end and the belt entrance end.

In some aspects, when the tension member is held between the first clamping surface and the second clamping surface, fasteners closer to the linkage end are tightened to provide greater clamp pressure than the fasteners closer to the belt entrance end.

Further embodiments of the present disclosure will now be described in the following numbered clauses:

Clause 1. An elevator system, comprising: at least one elevator car configured to be raised and lowered by a tension member; and an end termination clamp for the tension member comprising: a linkage configured for connection to a structural element; a first plate opposite a second plate defining a space therebetween to accept the tension member, each of the first plate and the second plate having a linkage end connected to the linkage, a belt entrance end, and a main body extending between the linkage end and the belt entrance end, the first plate defining a first clamping surface configured to abut a first side of the tension member, and the second plate defining a second clamping surface configured to abut a second side of a tension member; at least one fastener connecting the first plate and the second plate to clamp the tension member in the space between the first plate and the second plate; wherein the first clamping surface and the second clamping surface are narrower than a width of the tension member at the belt entrance end of the first plate and the second plate.

Clause 2. The elevator system of clause 1, wherein the belt entrance end of the first plate and the second plate tapers inward from the main body such that a width of the belt entrance end is narrower than a width of the main body for each of the first plate and the second plate.

Clause 3. The elevator system of clause 1 or 2, wherein at least a portion of the belt entrance end of the first plate and the second is curved.

Clause 4. The elevator system of any of clauses 1-3, wherein the curved portion of the belt entrance end of the first plate and the second plate has a predetermined radius of curvature of between about 5 mm and about 200 mm.

Clause 5. The elevator system of any of clauses 1-4, wherein the belt entrance end of the first plate and the second plate narrows inward from the main body and defines a polygonal shape.

Clause 6. The elevator system of any of clauses 1-5, wherein the polygonal shape is trapezoidal.

Clause 7. The elevator system of any of clauses 1-6, wherein the belt entrance end of the first plate and the second plate is asymmetric about a longitudinal axis parallel to the tension member and bisecting the main body of the first plate and the second plate.

Clause 8. The elevator system of any of clauses 1-7, wherein each of the first clamping surface and the second clamping surface is asymmetric about a longitudinal axis parallel to the tension member and bisecting the main body of the first plate and the second plate.

Clause 9. The elevator system of any of clauses 1-8, wherein the asymmetrical shape of the first clamping surface and the second clamping surface are selected to define a predetermined clamp pressure profile to the tension member.

Clause 10. The elevator system of any of clauses 1-9, wherein the main body of at least one of the first plate and the second plate defines a window through which a held end of the tension member is visible.

Clause 11. The elevator system of any of clauses 1-10, wherein the belt entrance end of the first plate and the second plate is deflectable relative to the main body of the first plate and the second plate.

Clause 12. The elevator system of any of clauses 1-11, wherein the belt entrance end is deflectable in a direction parallel to a direction of transverse sway or lateral sway of the tension member held between the first clamping surface and the second clamping surface.

Clause 13. The elevator system of any of clauses 1-12, further comprising a sway brake extending from the main body of the first plate and the second plate and engaging the tension member held between the first clamping surface and the second clamping surface.

Clause 14. The elevator system of any of clauses 1-13, wherein the sway brake comprises a damper to counteract lateral sway of the tension belt of the tension member held between the first clamping surface and the second clamping surface.

Clause 15. The elevator system of any of clauses 1-14, wherein the at least one fastener comprises a plurality of fasteners connecting the first plate and the second plate to clamp the tension member in the space between the first plate and the second plate, the plurality of fasteners distributed evenly on the main body of the first plate and the second plate between the linkage end and the belt entrance end.

Clause 16. The elevator system of any of clauses 1-15, wherein the fasteners closer to the linkage end are tightened to provide greater clamp pressure than the fasteners closer to the belt entrance end.

Clause 17. A method for connecting an end termination clamp to an elevator tension member, the method comprising: providing a first plate opposite a second plate to define a space therebetween, each of the first plate and the second plate having a linkage end, a belt entrance end, and a main body extending between the linkage end and the belt entrance end, the first plate defining a first clamping surface, and the second plate defining a second clamping surface; inserting the tension member into the space between the first plate and the second plate such that the first clamping surface abuts a first side of the tension member and the second clamping surface abuts a second side of the tension member; and connecting the first plate and the second plate with at least one fastener to clamp the tension member in the space between the first plate and the second plate; wherein the first clamping surface and the second clamping surface are narrower than a width of the tension member at the belt entrance end of the first plate and the second plate.

Clause 18. The method of clause 17, further comprising connecting a linkage to the linkage end of the first plate and the second plate.

Clause 19. The method of clause 17 or 18, wherein the at least one fastener comprises a plurality of fasteners connecting the first plate and the second plate to clamp the tension member in the space between the first plate and the second plate, the plurality of fasteners distributed evenly on the main body of the first plate and the second plate between the linkage end and the belt entrance end, the method further comprising tightening the fasteners closer to the linkage end to provide greater clamp pressure than the fasteners closer to the belt entrance end.

Clause 20. The method of any of clauses 17-19, wherein the step of tightening the fasteners closer to the linkage end to provide greater clamp pressure than the fasteners closer to the belt entrance end comprises using one of a linearly increasing or an exponentially increasing clamp pressure for the plurality of fasteners between the linkage end and the belt entrance end.

Clause 21. An end termination clamp for a tension member comprising: a linkage configured for connection to a structural element; a first plate opposite a second plate defining a space therebetween to accept the tension member, each of the first plate and the second plate having a linkage end connected to the linkage, a belt entrance end, and a main body extending between the linkage end and the belt entrance end, the first plate defining a first clamping surface configured to abut a first side of a tension member, and the second plate defining a second clamping surface configured to abut a second side of a tension member; at least one fastener connecting the first plate and the second plate to clamp the tension member in the space between the first plate and the second plate; wherein the first clamping surface and the second clamping surface are narrower than the width of the tension member at the belt entrance end of the first plate and the second plate.

Clause 22. The end termination clamp of clause 21, wherein the belt entrance end of the first plate and the second plate tapers inward from the main body such that a width of the belt entrance end is narrower than the width of the main body for each of the first plate and the second plate.

Clause 23. The end termination clamp of clause 21 or 22, wherein at least a portion of the belt entrance end of the first plate and the second is curved.

Clause 24. The end termination clamp of any of clauses 21-23, wherein the curved portion of the belt entrance end of the first plate and the second plate have a predetermined radius of curvature of between about 5 mm and about 200 mm.

Clause 25. The end termination clamp of any of clauses 21-24, wherein the belt entrance end of the first plate and the second plate narrows inward from the main body and defines a polygonal shape.

Clause 26. The end termination clamp of any of clauses 21-25, wherein the polygonal shape is trapezoidal.

Clause 27. The end termination clamp of any of clauses 21-26, wherein the belt entrance end of the first plate and the second plate is asymmetric about a longitudinal axis parallel to the tension member and bisecting the main body of the first plate and the second plate.

Clause 28. The end termination clamp of any of clauses 21-27, wherein each of the first clamping surface and the second clamping surfaces is asymmetric about a longitudinal axis parallel to the tension member and bisecting the main body of the first plate and the second plate.

Clause 29. The end termination clamp of any of clauses 21-28, wherein asymmetrical shape of the first clamping surface and the second clamping surface are selected to define a predetermined clamp pressure profile to the tension member.

Clause 30. The end termination clamp of any of clauses 21-29, wherein the main body of at least one of the first plate and the second plate defines a window through which a held end of the tension member is visible.

Clause 31. The end termination clamp of any of clauses 21-30, wherein the belt entrance end of the first plate and the second plate is deflectable relative to the main body of the first plate and the second plate.

Clause 32. The end termination clamp of any of clauses 21-31, wherein the belt entrance end is deflectable in a direction parallel to a direction of transverse sway or lateral sway when the tension member is held between the first clamping surface and the second clamping surface.

Clause 33. The end termination clamp of any of clauses 21-32, further comprising a sway brake extending from the main body of the first plate and the second plate and engaging the tension member when the tension member is held between the first clamping surface and the second clamping surface.

Clause 34. The end termination clamp of any of clauses 21-33, wherein the sway brake comprises a damper to counteract lateral sway of the tension belt when the tension member is held between the first clamping surface and the second clamping surface.

Clause 35. The end termination clamp of any of clauses 21-34, wherein the at least one fastener comprises a plurality of fasteners connecting the first plate and the second plate to clamp the tension member in the space between the first plate and the second plate, the plurality of fasteners distributed evenly on the main body of the first plate and the second plate between the linkage end and the belt entrance end.

Clause 36. The end termination clamp of any of clauses 21-35, wherein when the tension member is held between the first clamping surface and the second clamping surface, fasteners closer to the linkage end are tightened to provide greater clamp pressure than the fasteners closer to the belt entrance end.

These and other features and characteristics of a tension member end termination clamp, as well as methods for connecting a tension member end termination clamp to an elevator tension member and elevator systems including the tension member end termination clamp, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and claims, the singular forms of “a”, “an”, and “the” include plural referents unless the context clearly dictates otherwise.

### BRIEF DESCRIPTION OF THE DRAWINGS

FIG. 1 is a perspective view of a tension member end termination clamp according to an aspect of the present disclosure showing a tension member secured thereto;

FIG. 2 is a side view of the end termination clamp of FIG. 1, showing the tension member secured thereto;

FIG. 3 is a perspective view of an elevator system utilizing a plurality of tension member end terminations according to an aspect of the present disclosure;

FIG. 4 is an exploded perspective view of the end termination clamp of FIG. 1 with the tension member;

FIG. 5 is a partial perspective view of a belt entrance end of the tension member end termination clamp of FIG. 1, showing the tension member secured thereto;

FIG. 6 is a partial side view of the tension member end termination clamp of FIG. 1;

FIG. 7 side view of the tension member end termination clamp of FIG. 1, showing the tension member secured thereto, and showing a graph of clamping force applied along the length of the tension member end termination clamp;

FIG. 8 is a partial perspective view of the tension member end termination clamp of FIG. 1, showing the tension member secured thereto;

FIG. 9 is a partial side view of the tension member end termination clamp according to another aspect of the present disclosure, showing a tension member secured thereto;

FIG. 10 is a partial front view of the tension member end termination clamp according to another aspect of the present disclosure, showing a tension member secured thereto;

FIG. 11 is a schematic front view of the tension member end termination clamp according to another aspect of the present disclosure, illustrating deflection of the belt entrance end thereof;

FIG. 12 is a schematic front view of the tension member end termination clamp according to another aspect of the present disclosure, illustrating deflection of the belt entrance end thereof;

FIG. 13 is a partial side view of the tension member end termination clamp according to another aspect of the present disclosure, showing the tension member secured thereto; and

FIG. 14 is a partial side view of the tension member end termination clamp according to another aspect of the present disclosure, showing the tension member secured thereto.

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the disclosed apparatus as it is oriented in the figures. However, it is to be understood that the apparatus of the present disclosure may assume alternative variations and step sequences, except where expressly specified to the contrary. It is also to be understood that the specific systems and processes illustrated in the attached drawings and described in the following specification are simply exemplary examples of the apparatus disclosed herein. Hence, specific dimensions and other physical characteristics related to the examples disclosed herein are not to be considered as limiting.

As used herein, the terms “sheave” and “pulley” are used interchangeably to describe a wheel for tractive connection to a tension member of any type. It is to be understood that a “pulley” is encompassed by the recitation of a “sheave”, and vice versa, unless explicitly stated to the contrary.

As used herein, the terms “substantially” or “approximately”, when used to relate a first numerical value or condition to a second numerical value or condition, means that the first numerical value or condition is within 10 units or within 10% of the second numerical value or condition, as the context dictates and unless explicitly indicated to the contrary. For example, the term “substantially parallel to” means within plus or minus 10° of parallel. Similarly, the term “substantially perpendicular to” means within plus or minus 10° of perpendicular. Similarly, the term “substantially equal in volume” means within 10% of being equal in volume.

As used herein, the terms “transverse”, “transverse to”, and “transversely to” a given direction mean not parallel to that given direction. Thus, the terms “transverse”, “transverse to”, and “transversely to” a given direction encompass directions perpendicular to, substantially perpendicular to, and otherwise not parallel to the given direction.

As used herein, the term “distal” means in a direction along the tension member away from the structural element of the elevator to which the end termination clamp is attached. The term “proximal” means in a direction along the tension member towards the structural element of the elevator to which the end termination clamp is attached

As used herein, the term “at least one of” is synonymous with “one or more of”. For example, the phrase “at least one of A, B, and C” means any one of A, B, or C, or any combination of any two or more of A, B, or C. For example, “at least one of A, B, and C” includes one or more of A alone; or one or more of B alone; or one or more of C alone; or one or more of A and one or more of B; or one or more of A and one or more of C; or one or more of B and one or more of C; or one or more of all of A, B, and C. Similarly, as used herein, the term “at least two of” is synonymous with “two or more of”. For example, the phrase “at least two of D, E, and F” means any combination of any two or more of D, E, or F. For example, “at least two of D, E, and F” includes one or more of D and one or more of E; or one or more of D and one or more of F; or one or more of E and one or more of F; or one or more of all of D, E, and F.

Referring to the drawings in which like reference numerals refer to like parts throughout the several views thereof, the present disclosure is generally directed to a clamp type belt end termination for use on a tension member of an elevator system. It is to be understood, however, that the clamp type belt end termination described herein may be used in many different applications in which tension members are mounted to structural elements. The present disclosure is also directed to an elevator system utilizing the clamp type belt end termination. The present disclosure is further directed to methods of connecting an end termination clamp to an elevator tension member.

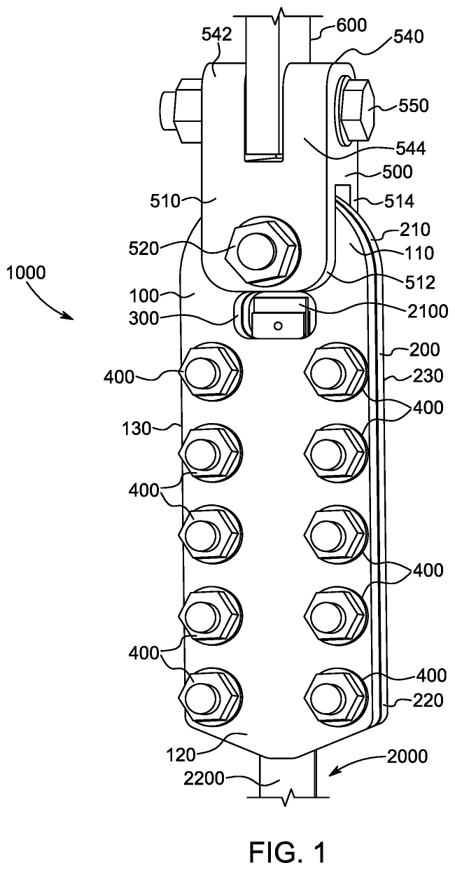

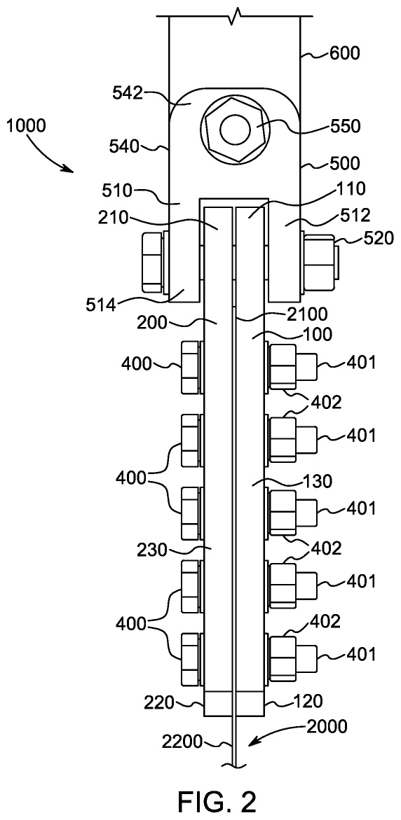

Referring now to FIGS. 1-2, an end termination clamp 1000 according to aspects of the present disclosure is shown connected to a tension member 2000 of an elevator system 5000. The end termination clamp 1000 includes a first plate 100 and a second plate 200 arranged opposite one another and defining a space therebetween to accept or receive the tension member 2000. The first plate 100 has a linkage end 110, a belt entrance end 120 located distally of the linkage end 110, and a main body 130 extending between the linkage end 110 and the belt entrance

end 120. Similarly, the second plate 200 has a linkage end 210, a belt entrance end 220 located distally of the linkage end 210, and a main body 230 extending between the linkage end 210 and the belt entrance end 220. The tension member 2000 is received into the end termination clamp 1000 at the belt entrance ends 120, 220 of the first and second plates 100, 200 and extends proximally between the first and second plates 100, 200 towards the linkage ends 110, 210. The tension member 2000 may be positioned between the first plate 100 and the second plate 200 such that a held end 2100 of the tension member 2000 is visible through an inspection window 300 defined in either or both of the main bodies 130, 230 of the first plate 100 and the second plate 200. In other aspects, the window 300 may be omitted such that the held end 2100 of the tension member 2000 is hidden between the first plate 100 and the second plate 200 when the end termination clamp 1000 is viewed substantially from the front or rear (as in FIG. 1).

The first plate 100 and the second plate 200 are retained opposite one another with the tension member 2000 positioned therebetween by at least one fastener 400 connecting the first plate 100 to the second plate 200. In some aspects, each fastener 400 may include a bolt 401 extending through each of the first and second plates 100, 200 and a nut 402 threaded onto a shank of the bolt 401. In other aspects, one of the first plate 100 or the second plate 200 may include threaded holes such that the nut 402 is not necessary. Tightening the at least one fastener 400 draws the first plate 100 and the second plate 200 closer together and into contact with opposite sides of the tension member 2000. After the first plate 100 and the second plate 200 have contacted the tension member 2000, further tightening of the at least one fastener 400 introduces a clamping force to the tension member 2000. The at least one fastener 400 may be tightened to such a degree that the clamping force creates sufficient friction between the tension member 2000 and the first and second plates 100, 200 to at least partially prevent slippage of the tension member 2000 when a pulling force is applied to a free end 2200 of the tension member 2000.

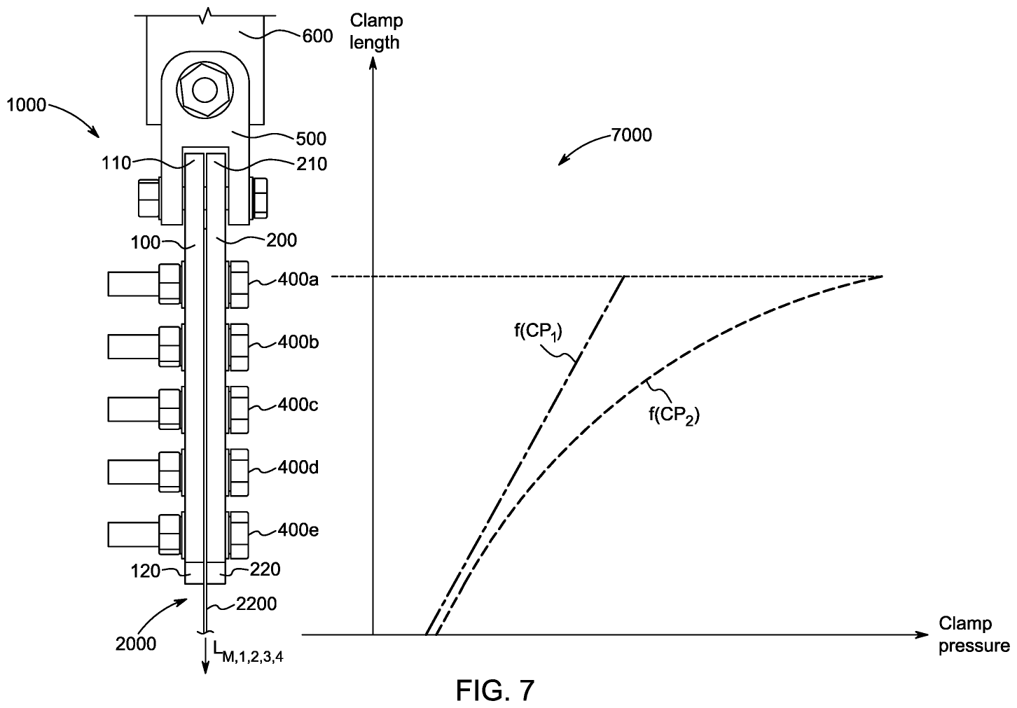

The at least one fastener 400 may include a plurality of fasteners 400 arranged around a portion of the tension member 2000 that is secured between the first plate 100 and the second plate 200. The plurality of fasteners 400 may be distributed around the tension member 2000 according to a predetermined pattern to dictate the locations and degrees at which clamping forces are imparted to the tension member 2000 via the first plate 100 and the second plate 200. In some aspects, the plurality of fasteners 400 may be evenly distributed along the main bodies 130, 230 on each side of the tension member 2000. Each of the fasteners 400 may be individually adjustable to control the clamping force imparted to the tension member 2000 by the first and second plates 100, 200. Additional considerations for the arrangement and tightening of the at least one fastener 400 will be discussed in greater detail herein with reference to FIG. 7.

While the at least one fastener 400 has heretofore been particularly described as a bolt 401 and nut 402 combination, it is to be understood that other types of mechanical fasteners, both adjustable and non-adjustable, are suitable and within the scope of this disclosure. For example, the at least one fastener 400 may be a rivet, cam lock, latch, or the like.

The linkage ends 110, 210 of the first plate 100 and the second plate 200 may be connected to a linkage 500, which, in turn, connects to a structural element 600 of an elevator system 5000. In some aspects, the linkage 500 may include a first clevis end 510 configured to be pivotally mounted to the first plate 100 and the second plate 200. The first clevis end 510 may include a first tab 512 and a second tab 514 between which the first plate 100 and the second plate 200 may be aligned. A clevis fastener 520, such as a bolt or pin, may be inserted through axially aligned holes in the first tab 512, the second tab 514, the first plate 100, and the second plate 200 to connect the linkage 500 to the first and second plates 100, 200. The clevis fastener 520 may permit rotation of the first and second plates 100, 200 relative to the linkage 500 to account for misalignment of the tension member 2000 relative to the structural element 600. Thus, the first and second plates 100, 200 may self-align parallel to the tension member 2000 to avoid imparting torsional and/or transverse shear loads to the tension member 2000.

In some aspects, the linkage 500 may include a second clevis end 540 configured to be pivotally mounted to the structural element 600 of the elevator system 5000. The second clevis end 540 may include a first tab 542 and a second tab 544 between which the structural component 600 may be aligned. A clevis fastener 550, such as a bolt or pin, may be inserted through axially aligned holes in the first tab 542, the second tab 544, and the structural element 600 to connect the linkage 500 to the structural element 600. The clevis fastener 520 may permit rotation of the linkage 500, the first plate 100, and the second plate 200 relative to the structural element 600 to account for misalignment of the tension member 2000 relative to the structural element 600. In some aspects, the second clevis end 540 may be rotated approximately 90° relative to the first clevis end 510 such that each of the first and second clevis ends 510, 540 permit rotation of the first and second plates 100, 200 about different axes, thereby providing two degrees of freedom of rotation of the first and second plates 100, 200.

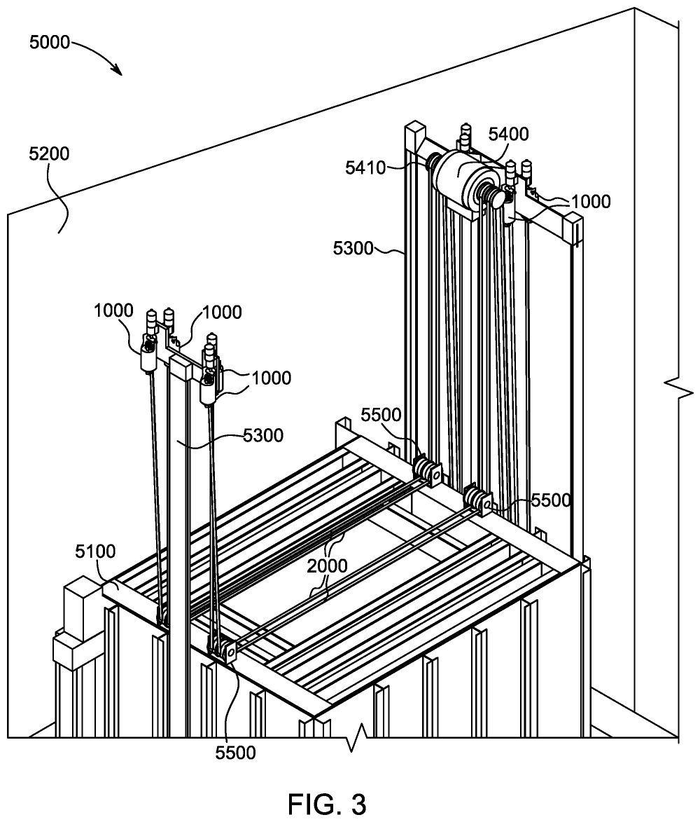

The structural element 600 may be any stationary or movable component of the elevator system 5000 to which the held end 2100 of the tension member 2000 is attached. An example of one such elevator system 5000 utilizing a plurality of the end termination clamps 1000 is illustrated in FIG. 3. The elevator system 5000 may include an elevator car 5100 and counterweight (not shown) each movable along a vertical travel path defined by one or more elevator shafts 5200. One or more tension members 2000 may be utilized to raise and/or lower the elevator car 5100 and/or the counterweight. In the aspect shown in FIG. 3, the elevator system 5000 includes four tension members 2000, each of which is mounted to a stationary support frame 5300 of the elevator system 5000 via an end termination clamp 1000 secured at each end of each tension member 2000.

The tension members 2000 are routed around drive sheaves 5410 rotatable by at least one drive motor 5400. The drive sheaves 5410 frictionally engage the tension members 2000 between opposing ends of the tension members 2000 such that rotation of the drive sheaves 5410 increases or decreases the length of each tension member 2000 between a first end the of the tension member 2000 and the drive arrangement 5400. Rotation of the drive sheaves 5410 thus causes the elevator car 5100 to raise or lower depending on the direction of rotation of the drive sheaves 5410 and the arrangement of the counterweight, and the end termination clamps 1000.

The tension members 2000 may further be routed around any number of elevator sheaves 5500 to alter the direction of the tension force applied by the tension members 2000 on the elevator car 5100 and the counterweight. The elevator sheaves 5500 may be attached to any portion of the elevator system 5000 including the support frame 5300, the elevator car 5100, the counterweight, and/or a floor, a ceiling, or a wall of the elevator shafts 5200. In other, not-shown aspects, the elevator system 5000 may utilize a one-to-one roping arrangement in which no elevator sheaves 5500 are utilized. Rather, opposite ends of each tension member 2000 may be affixed directly to the elevator car 5100 and the counterweight via end termination clamps 1000.

As may be appreciated from the elevator system 5000 of FIG. 3, the structural element 600 of FIGS. 1-2 to which linkage 500 is connected may be any component suitable of the elevator system 5000 including, for example, the elevator shafts 5200 or the stationary support frame 5300. In examples of an elevator system 5000 utilizing a one-to-one roping arrangement, as described above but not shown, the structural element may further be the elevator car 5100 or the counterweight. The structural element 600 may include a bar, rod end, or the like suitable for connection to the linkage 500 as described above. In some aspects, the structural element 600 may further include a compression or tension spring to mitigate and/or absorb shock loads imparted to the tension member 2000.

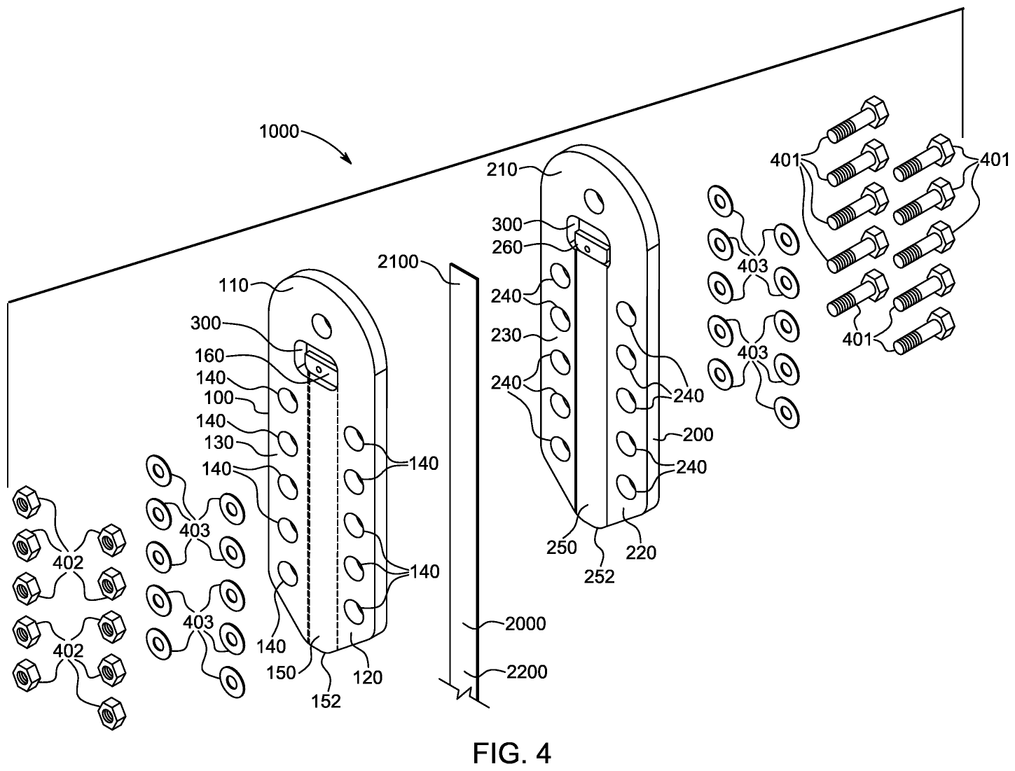

Referring now to FIG. 4, the end termination clamp 1000 of FIGS. 1-2 is shown in an exploded view without the linkage 500 to illustrate the connection of the first plate 100 to the second plate 200 holding the tension member 2000 therebetween. As described above, the at least one fastener 400 draws the first and second plates 100, 200 together to secure the tension member 2000 between the first and second plates 100, 200. As further discussed above, in some aspects, the at least one fastener may include a plurality of bolts 401 insertable through aligned holes 140, 240 formed in the first and second plates 100, 200, respectively. Each of the bolts 401 may be secured and tightened by a corresponding nut 402. Additionally, one or more washers 403 may be arranged under the head of each bolt 401, under each nut 402, or in both or neither locations.

As a supplemental measure to secure the tension member 2000 to the first and second plates 100, 200 and/or to monitor slippage of the tension member 2000, a termination block 160, 260 may be affixed to either or both sides of the tension member 2000. The termination blocks 160, 260 may be affixed to the held end 2100 of the tension member 2000 via an adhesive, glue, or the like, and may extend into the inspection windows 300 defined in the first and second plates 100, 200.

The first plate 100 may define a first clamping surface 150 configured to abut a first side of the tension member 2000. Similarly, the second plate 200 may define a second clamping surface 250 configured to abut a second side of the tension member 2000 opposite the first side abutted by the first clamping surface 150. The first clamping surface 150 may extend at least partially the length of the first plate 100 between the linkage end 110 and the belt entrance end 120 thereof. Similarly, the second clamping surface 250 may extend at least partially the length of the second plate 200 between the linkage end 210 and the belt entrance end 220 thereof.

In FIG. 4, the second clamping surface 250 is illustrated in solid lines for the purposes of describing the second clamping surface 250 relative to the remainder of the second plate 200, which does not contact the tension member 2000. However, it is to be understood that the second clamping surface 250 may not be visually distinguishable from the remainder of the second plate 200, as the second clamping surface 250 may be continuously formed or machined with the remainder of the second plate 200. In other aspects, however, the second clamping surface 250 may have a surface treatment or finish to promote friction with the tension member 2000 or to reduce wear on the tension member 2000. In such aspects, the second clamping surface 250 may therefore be visually distinguishable from the remainder of the second plate 200.

The first clamping surface 150 is illustrated in broken lines to indicate that the first clamping surface 150 is located on the face of the first plate 100 hidden from view in FIG. 4. Like the second clamping surface 250, the first clamping surface 150 may not be visually distinguishable from the remainder of the first plate 100, as the first clamping surface 150 may be continuously formed or machined with the remainder of the first plate 100. In other aspects, however, the first clamping surface 150 may have a surface treatment or finish to promote friction with the tension member 2000 or to reduce wear on the tension member 2000. In such aspects, the first clamping surface 150 may therefore be visually distinguishable from the remainder of the first plate 100.

As will be appreciated from FIGS. 1, 2, and 4, the first and second plates 100, 200 may taper, narrow, or otherwise be inwardly reduced in width at or near the belt entrance ends 120, 220 thereof. As such, a distal end 152 of the first clamping surface 150 at or near the belt entrance end 120 may be narrower than the width of the tension member 2000, and a distal end 252 of the second clamping surface 250 at or near the belt entrance end 220 may be narrower than the width of the tension member 2000. As a result, the distal ends 152, 252 of the first and second clamping surfaces 150, 250 do not contact and therefore do not apply a clamping force to the edges of the tension member 2000. Rather, at the distal ends 152, 252 of the first and second clamping surfaces 150, 250, the first and second clamping surfaces 150, 250 apply a clamping force to only an inner portion of the width of the tension member 2000. The first and second clamping surfaces 150, 250 gradually increase in width along a proximal direction of the first and second plates 100, 200, thereby increasing the portion of the width of the tension member 2000 over which the clamping force is applied.

Because the distal ends 152, 252 of the first and second clamping surfaces 150, 250 contact only the inner portion of the tension member 2000, axial loads applied to the tension member 2000 are first transmitted to the inner portion of the tension member 2000 and gradually propagate towards the edges of the tension member 2000 along the profile of the first and second clamping surfaces 150, 250. As a result, stress concentrations at or near the edges of the tension member 2000 are reduced.

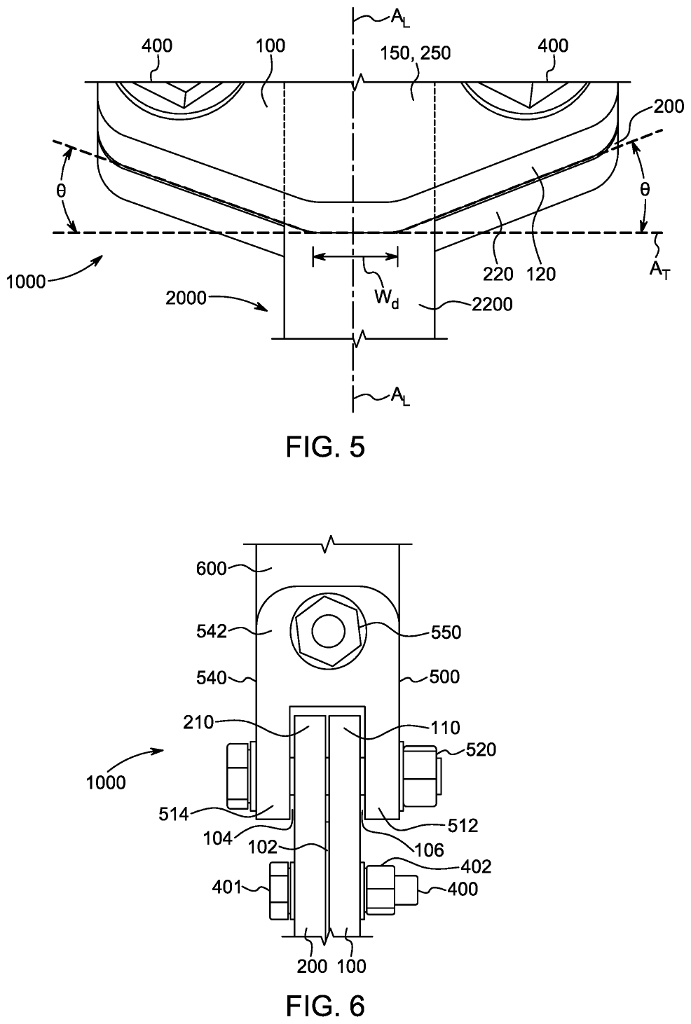

FIG. 5 shows an aspect of the belt entrance ends 120, 220 of the first and second plates 100, 200. The belt entrance ends 120, 220 may taper, narrow, or otherwise be inwardly reduced in width from the main bodies 130, 230 in a distal direction of the first and second plates 100, 200 to define the first and second clamping surfaces 150, 250. In particular, the first and second plates 100, 200 may have an angular taper symmetrical about a longitudinal axis A_{L} bisecting the main bodies 130, 230 and defined by a taper angle θ relative to a transverse axis A_{T} of the end termination clamp 1000. A distal-most portion of the first and second plates 100, 200 may have a width w_{D} of less than the width of the tension member 2000. As such, the belt entrance ends 120, 220 may have a polygonal, such as a trapezoidal, shape. The first and second clamping surfaces 150, 250, which are hidden from view in FIG. 5, may follow the profile of the belt entrance ends 120, 220 such that the first and second clamping surfaces 150, 250 have the same distal width w_{D} and taper angle θ as the first and second plates 100, 200. The distal width w_{D} and taper angle θ may be selected to optimize the transfer of loads from the inner portion of the tension member 2000 to the edges of the tension member 2000, while reducing the formation of stress concentrations at the edges of the tension member 2000. For example, the taper angle θ may be between 10° and 40°, such as approximately 22°. The distal width w_{D} may be between 40% and 90% of the width of the tension member 2000, such as 80% of the width of the tension member 2000.

Referring now to FIG. 6, in some aspects of the present disclosure, the end termination clamp 1000 may be configured to accommodate tension members 2000 having different thicknesses. When the tension member 2000 is secured between the first plate 100 and the second plate 200, a space 102 corresponding to the thickness of the tension member 2000 is defined between the first and second plates 100, 200. In some aspects, the first clevis end 510 of the linkage 500 may define one or more compensation gaps 104, 106 between the first tab 512 and the first plate 100 and/or between the second tab 514 and the second plate 200. The compensation gaps 104, 106 allow the space 102 between the first and second plates 100, 200 to be increased, such as when a thicker tension member 2000 is utilized. For example, the compensation gaps 104, 106 may facilitate use of tension members 2000 having a thickness between 0.3 mm and 6.0 mm.

FIG. 7 provides a graphical representation of the clamping pressure imparted to the tension member 2000 according to different aspects of a method for connecting the tension member 2000 to the end termination clamp 1000. As explained above, the tension member 2000 may be connected to the end termination clamp 1000 by positioning the tension member 2000 between the first and second plates 100, 200 and tightening the at least one fastener 400 to draw the first and second plates 100, 200 together. In aspects in which the at least one fastener 400 includes a plurality of fasteners 400, each of the fasteners 400 may be individually tightened to apply a predetermined amount of clamping pressure at specific locations along the end termination clamp 1000. Varying the clamping pressure applied along the length of end termination clamp 1000 reduces stress concentrations and shock load failures in the tension member 2000 by allowing progressively more slippage of the tension member 2000 towards the belt entrance ends 120, 220 of the first and second plates 100, 200.

Graph 7000 shows clamp pressure plotted against clamp length for an end termination clamp 1000 having a plurality of fasteners 400a-400e evenly distributed in a longitudinal direction of the end termination clamp 1000. A first clamp pressure function f(CP₁) linearly varies the clamp pressure applied to the tension member 2000, with a maximum clamp pressure applied by the fastener 400a nearest the linkage ends 110, 210 and a minimum clamp pressure applied by the fastener 400e nearest the belt entrance ends 120, 220. The clamp pressure applied by each fastener 400a-400e may be set and/or adjusted by tightening each fastener 400a-400e until a predetermined clamp pressure has been reached.

Similarly, a second clamp pressure function f(CP₂) exponentially varies the clamp pressure applied to the tension member 2000, with a maximum clamp pressure applied by the fastener 400a nearest the linkage ends 110, 210 and a minimum clamp pressure applied by the fastener 400e nearest the belt entrance ends 120, 220. It should be understood that by individually altering the clamp pressure applied by each fastener 400a-400e, an unlimited number of clamp pressure functions may be achieved.

In both the first clamp pressure function f(CP₁) and the second clamp pressure function f(CP₂), the fastener 400a nearest the linkage ends 110, 210 may be tightened to apply a sufficient clamp pressure to prevent slippage of the tension member 2000 relative to the first and second plates 100, 200 when a maximum operational load L_{M} is applied to the free end 2200 of the tension member 2000. Each successive fastener 400b-400e may be tightened to permit incrementally more slippage of the tension member 2000 relative to the first and second plates 100, 200 when the maximum operational load is applied to the free end 2200 of the tension member 2000. That is, the fastener 400b may permit a first amount of slippage of the tension member 2000 when the maximum operational load L_{M} is applied to the tension member 2000. The subsequent fastener 400c may permit a second amount of slippage, greater than the first amount of slippage, of the tension member 2000 when the maximum operational load L_{M} is applied to the tension member 2000. The subsequent fastener 400d may permit a third amount of slippage, greater than the second amount of slippage, of the tension member 2000 when the maximum operational load L_{M} is applied to the tension member 2000. The final fastener 400e may permit a fourth amount of slippage, greater than the third amount of slippage, of the tension member 2000 when the maximum operational load L_{M} is applied to the tension member 2000.

Described another way, each successive fastener 400b-400e may be tightened to apply a sufficient clamp pressure to prevent slippage of the tension member 2000 relative to the first and second plates 100, 200 when a progressively less sub-maximum operational load L_{1, 2, 3, 4} is applied to the free end 2200 of the tension member 2000. For example, the fastener 400b may permit slippage of the tension member 2000 at the maximum operation load L_{M}, but may prevent slippage of the tension member 2000 at a first sub-maximum operational load L₁, where the first sub-maximum operational load L₁ is less than the maximum operation load L_{M}. The subsequent fastener 400c may permit slippage of the tension member 2000 at the first sub-maximum operational load L₁, but may prevent slippage of the tension member 2000 at a second sub-maximum operational load L₂, where the second sub-maximum operational load L₂ is less than the first sub-maximum operational load L₁. The subsequent fastener 400d may permit slippage of the tension member 2000 at the second sub-maximum operational load L₂, but may prevent slippage of the tension member 2000 at a third sub-maximum operational load L₃, where the third sub-maximum operational load L₃ is less than the second sub-maximum operational load L₂. The final fastener 400e may permit slippage of the tension member 2000 at the third sub-maximum operational load L₃, but may prevent slippage of the tension member 2000 at a fourth sub-maximum operational load L₄, where the fourth sub-maximum operational load L₄ is less than the third sub-maximum operational load L₃. By permitting progressively greater amounts of slippage of the tension member 2000 towards the belt entrance ends 120, 220 of the first and second plates 100, 200, failure of the tension member 2000 due to shock loads may be reduced.

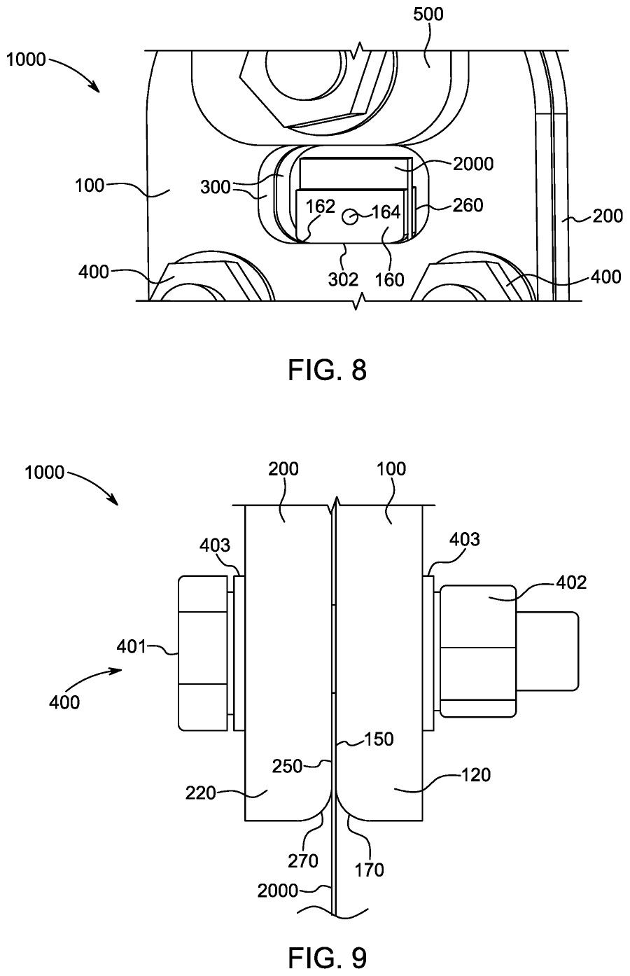

Referring now to FIG. 8, the inspection windows 300 and termination blocks 160, 260 included in some aspects of the present disclosure are now described in greater detail. As discussed above, the termination blocks 160, 260 may be connected to opposing sides of the tension member 2000 via an adhesive such as glue after the tension member 2000 has been secured to the first and second plates 100, 200. The termination block 160 corresponding to the inspection window 300 of the first plate 100 may include a curved or rounded bottom surface 162 configured to abut a support surface 302 of the corresponding inspection window 300. The curved or rounded bottom surface 162 allows the termination block 160 to align itself on the support surface 302 of the inspection window 300, thereby centering any loads transferred from the termination block 160 to the first plate 100. The termination block 160 may further include a threaded hole 164 to which an installation tool may be temporarily attached to assist an assembler in affixing the termination block 160 to the tension member 2000. The termination block 260 corresponding to the inspection window 300 of the second plate 200 may be substantially identical to or a mirror image of the termination block 160, although the features of the termination block 260 are obstructed from view in FIG. 8.

Referring now to FIG. 9, some aspects of the end termination clamp may include a chamfer or curve 170, 270 formed into the belt entrance ends 120, 220 of the first and second plates 100, 200. The curves 170, 270 may extend distally from the first and second clamping surfaces 150, 250 to contour the tension member 2000 if the tension member 2000 sways relative to the end termination clamp 1000. As a result, failure of the tension member 2000 due to bending-induced fatigue is reduced. Each curve 170, 270 may have a radius of curvature of, for example, between about 5 mm and about 200 mm. In other aspects, the curves 170, 270 may be replaced with or further include a bevel.

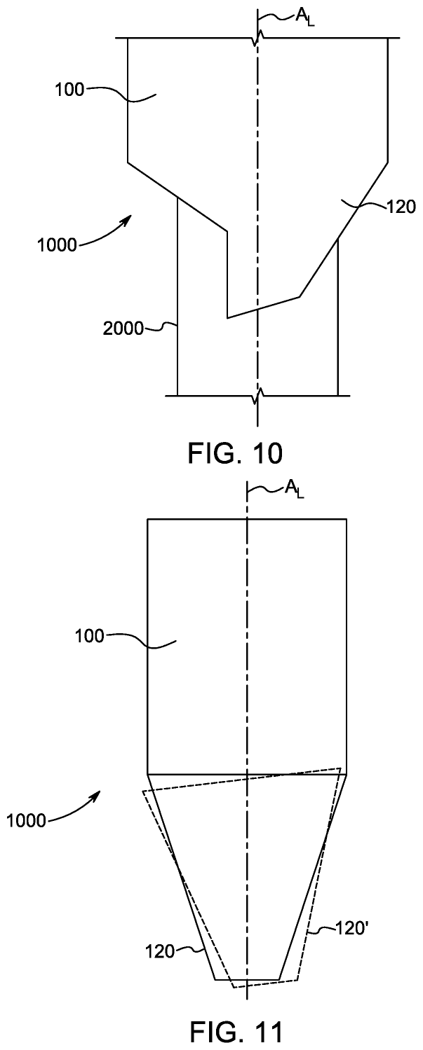

Referring now to FIG. 10, some aspects of the end termination clamp 1000 may have a belt entrance end 120 which is asymmetrical about the longitudinal axis A_{L} of the end termination clamp 1000. The first clamping surface 150 defined by the belt entrance end 120 may be similarly asymmetrical about the longitudinal axis A_{L} such that the first plate 100 contacts and applies clamp pressure to the tension member 2000 at different locations on the right and left sides of the longitudinal axis A_{L}. The belt entrance end 220 of the second plate 200 and the resulting second clamping surface 250 (none of which are shown in FIG. 10) may be substantially similar or identical to the belt entrance end 120 and the first clamping surface 150 of the first plate 100.

Due to the asymmetric application of clamp pressure, the maximum load experienced by the right side of the tension member 2000 may be induced to occur at a different transverse cross section of the tension member 2000 than the maximum load experienced on the left side of the tension member 2000. As a result, failures in the right and left sides of the tension member 2000 result in two distinct transverse cross sections being reduced in strength, each by a small amount, rather than one transverse cross section being reduced in strength by a large amount. Therefore, failures occurring at both the right and left sides of the tension member 2000 have a reduced negative effect on the overall strength and integrity of the tension member 2000 as compared to aspects in which right and left side failures both occur at the same transverse cross section of the tension member 2000. Additionally, the asymmetric application of clamp pressure converts some tension and compression loads on the tension member 2000 to torsional loads, further reducing fatigue. The asymmetrical shape of the belt entrance ends 120, 220 may be selected in order to define a desired, predetermined clamp pressure profile to the tension member 2000.

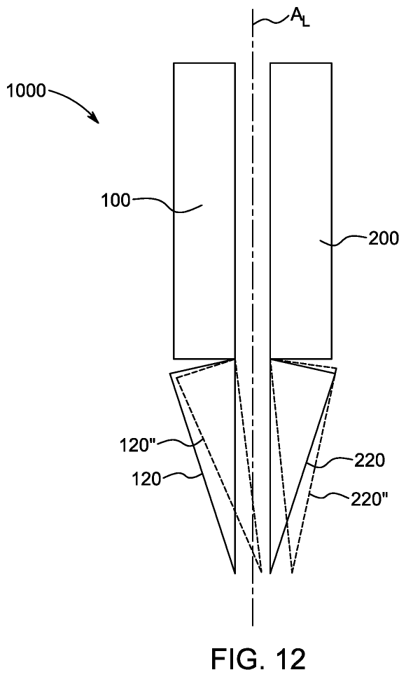

Referring now to FIGS. 11-12, some aspects of the end termination clamp 1000 may have belt entrance ends 120, 220 made from a resilient material such as spring steel or various composites. The resilient belt entrance ends 120, 220 may deflect relative to the main bodies 130, 230 to contour the tension member 2000 (not shown for clarity) and thereby reduce bending fatigue and failure. Additionally, deflection of the belt entrance ends 120, 220 may mitigate shock and/or impact loads experienced by the tension member 2000. As shown in FIG. 11, the belt entrance end 120 may be deflectable in a transverse direction to a transverse deflected state 120′. As shown in FIG. 12, the belt entrance ends 120, 220 may also be deflectable in a lateral direction to lateral deflected states 120″, 220″. The material for the belt entrance ends 120, 220 may be selected based on the anticipated loading of the tension member 2000. For example, a composite material including glass fiber reinforcement may be selected for sway dampening, and/or a composite the material including aramid fiber reinforcement may be selected for shock and impact resistance.

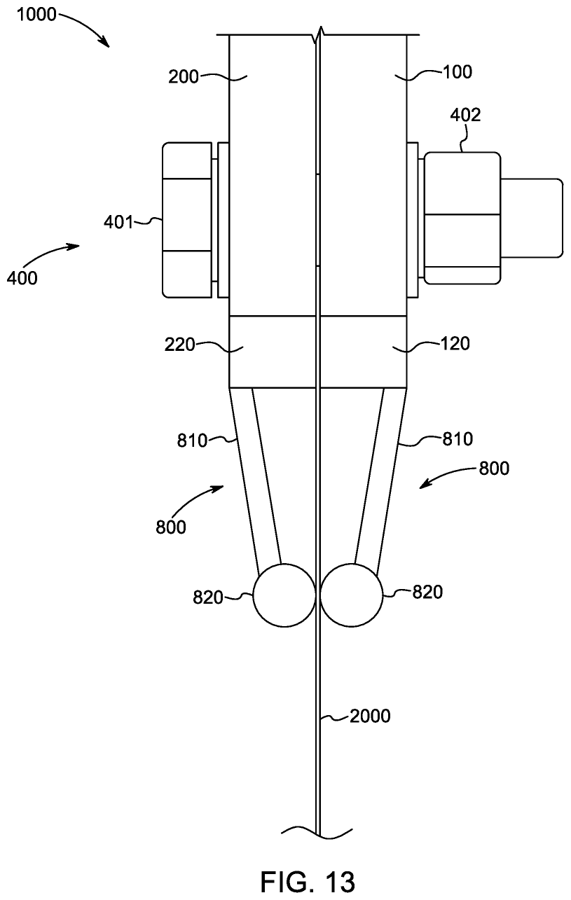

Referring now to FIG. 13, some aspects of the end termination clamp 1000 may include one or more sway brakes 800 extending distally from the first plate 100 and/or the second plate 200. Each sway brake 800 includes a resilient arm 810 mounted to the first plate 100 or the second plate 200. The resilient arm 810 extends distally along the tension member 2000 and terminates in a contact element 820 configured to engage a side of the tension member 2000. Lateral sway of the tension member 2000 relative to the end termination clamp 1000 displaces the contact element 820 and thereby deflects the resilient arm 810. The lateral sway may be at least partially absorbed and/or counteracted by the resilient arm 810, which induces the tension member 2000 back into alignment with the end termination clamp 1000. The resilient arm 810 may be made of spring steel, rubber, elastomer, composite materials, or the like.

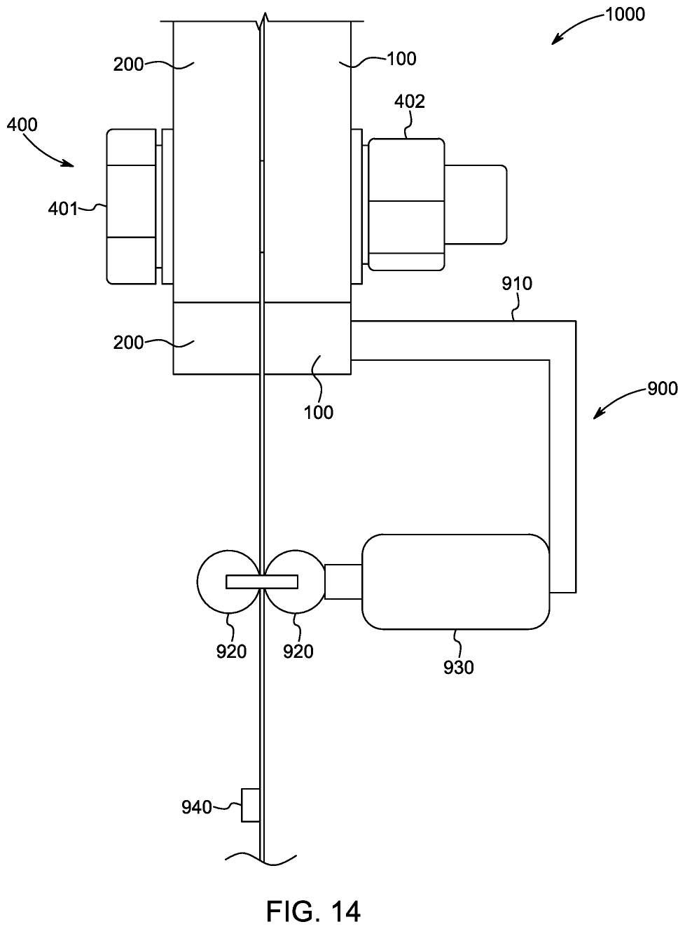

Referring now to FIG. 14, some aspects of the end termination clamp 1000 may include a dampened sway brake 900 extending distally from the first plate 100 and/or the second plate 200. The dampened sway brake 900 may include a connecting arm 910 connected to damper 930. The damper 930 may be connected to one or more contact elements 920 configured to engage one or both sides of the tension member 2000. The one or more contact elements 920 transmit lateral sway and/or oscillation of the tension member 2000 into the damper 930, which absorbs and/or dampers the motion of the tension member 2000, thereby inducing the tension member 2000 back into alignment with the end termination clamp 1000. The damper 930 may be active or passive. If active, the damper 930 may be include and electromechanical actuator programmed or configured to introduce controlled or predetermined oscillation into the tension member 2000 to counteract anticipated oscillation of the tension member 2000 due to operational loads. The dampened sway brake 900 may further include an oscillation sensor 940 mounted to the tension member 2000 distally of the damper 930. The oscillation sensor 940 may be configured to detect oscillation in the tension member 2000 prior to such oscillation reaching the end termination clamp 1000. The oscillation sensor 940 may be configured to transmit information regarding the detected oscillation to the damper 930. After receiving the oscillation information from the oscillation sensor 940, the damper 930 may introduce counteracting oscillation into the tension member 2000 in anticipation of the oscillation detected by the sensor 940 reaching the end termination clamp 1000. In this manner, oscillations in the tension member 2000 where the tension member 2000 enters the end termination clamp 1000 may be reduced, and fatigue experienced by the tension member 2000 may be mitigated.

While several examples of a clamp type belt end termination are shown in the accompanying figures and described in detail hereinabove, other examples will be apparent to and readily made by those skilled in the art without departing from the scope and spirit of the present disclosure. For example, it is to be understood that aspects of the various aspects described hereinabove may be combined with aspects of other aspects while still falling within the scope of the present disclosure. Accordingly, the foregoing description is intended to be illustrative rather than restrictive. The devices of the present disclosure described hereinabove are defined by the appended claims, and all changes to the disclosed devices that fall within the meaning and range of equivalency of the claims are to be embraced within their scope.

What is claimed is:

1. An elevator system, comprising:
at least one elevator car configured to be raised and lowered by a tension member; and
an end termination clamp for the tension member comprising:
a linkage configured for connection to a structural element;
a first plate opposite a second plate defining a space therebetween to accept the tension member, each of the first plate and the second plate having a linkage end connected to the linkage, a belt entrance end, and a main body extending between the linkage end and the belt entrance end, the first plate defining a first clamping surface configured to abut a first side of the tension member, and the second plate defining a second clamping surface configured to abut a second side of a tension member;
at least one fastener connecting the first plate and the second plate to clamp the tension member in the space between the first plate and the second plate;
wherein the first clamping surface and the second clamping surface are narrower than a width of the tension member at the belt entrance end of the first plate and the second plate.

2. The elevator system as claimed in claim 1, wherein the belt entrance end of the first plate and the second plate tapers inward from the main body such that a width of the belt entrance end is narrower than a width of the main body for each of the first plate and the second plate.

3. The elevator system as claimed in claim 1, wherein at least a portion of the belt entrance end of the first plate and the second is curved.

4. The elevator system as claimed in claim 3, wherein the curved portion of the belt entrance end of the first plate and the second plate has a predetermined radius of curvature of between about 5 mm and about 200 mm.

5. The elevator system as claimed in claim 1, wherein the belt entrance end of the first plate and the second plate narrows inward from the main body and defines a polygonal shape.

6. The elevator system as claimed in claim 5, wherein the polygonal shape is trapezoidal.

7. The elevator system as claimed in claim 1, wherein the belt entrance end of the first plate and the second plate is asymmetric about a longitudinal axis parallel to the tension member and bisecting the main body of the first plate and the second plate.

8. The elevator system as claimed in claim 1, wherein each of the first clamping surface and the second clamping surface is asymmetric about a longitudinal axis parallel to the tension member and bisecting the main body of the first plate and the second plate.

9. The elevator system as claimed in claim 8, wherein the asymmetrical shape of the first clamping surface and the second clamping surface are selected to define a predetermined clamp pressure profile to the tension member.

10. The elevator system as claimed in claim 1, wherein the main body of at least one of the first plate and the second plate defines a window through which a held end of the tension member is visible.

11. The elevator system as claimed in claim 1, wherein the belt entrance end of the first plate and the second plate is deflectable relative to the main body of the first plate and the second plate.

12. The elevator system as claimed in claim 11, wherein the belt entrance end is deflectable in a direction parallel to a direction of transverse sway or lateral sway of the tension member held between the first clamping surface and the second clamping surface.

13. The elevator system as claimed in claim 1, further comprising a sway brake extending from the main body of the first plate and the second plate and engaging the tension member held between the first clamping surface and the second clamping surface.

14. The elevator system as claimed in claim 13, wherein the sway brake comprises a damper to counteract lateral sway of the tension belt of the tension member held between the first clamping surface and the second clamping surface.

15. The elevator system as claimed in claim 1, wherein the at least one fastener comprises a plurality of fasteners connecting the first plate and the second plate to clamp the tension member in the space between the first plate and the second plate, the plurality of fasteners distributed evenly on the main body of the first plate and the second plate between the linkage end and the belt entrance end.

16. The elevator system as claimed in claim 15, wherein the fasteners closer to the linkage end are tightened to provide greater clamp pressure than the fasteners closer to the belt entrance end.

17. A method for connecting an end termination clamp to an elevator tension member, the method comprising:
providing a first plate opposite a second plate to define a space therebetween, each of the first plate and the second plate having a linkage end, a belt entrance end, and a main body extending between the linkage end and the belt entrance end, the first plate defining a first clamping surface, and the second plate defining a second clamping surface;
inserting the tension member into the space between the first plate and the second plate such that the first clamping surface abuts a first side of the tension member and the second clamping surface abuts a second side of the tension member; and
connecting the first plate and the second plate with at least one fastener to clamp the tension member in the space between the first plate and the second plate;
wherein the first clamping surface and the second clamping surface are narrower than a width of the tension member at the belt entrance end of the first plate and the second plate.

18. The method as claimed in claim 17, further comprising connecting a linkage to the linkage end of the first plate and the second plate.

19. The method as claimed in claim 17, wherein the at least one fastener comprises a plurality of fasteners connecting the first plate and the second plate to clamp the tension member in the space between the first plate and the second plate, the plurality of fasteners distributed evenly on the main body of the first plate and the second plate between the linkage end and the belt entrance end, the method further comprising tightening the fasteners closer to the linkage end to provide greater clamp pressure than the fasteners closer to the belt entrance end.

20. The method as claimed in claim 19, wherein the step of tightening the fasteners closer to the linkage end to provide greater clamp pressure than the fasteners closer to the belt entrance end comprises using one of a linearly increasing or an exponentially increasing clamp pressure for the plurality of fasteners between the linkage end and the belt entrance end.
